(19) United States
(12) Patent Application Publication
(10) Pub. No.: US 2013/0062881 A1
(43) Pub. Date: Mar. 14, 2013

(54) SYSTEM, APPARATUS AND METHOD FOR GENERATING POWER IN A FLUID CONDUIT

(71) Applicant: Khedher Mellah, Sugar Land, TX (US)

(72) Inventor: Khedher Mellah, Sugar Land, TX (US)

(73) Assignee: Chevron U.S.A. Inc., San Ramon, CA (US)

(21) Appl. No.: 13/232,688

(22) Filed: Sep. 14, 2011

(51) Int. Cl. F03B 13/00; H02K 7/18

(52) U.S. Cl. 290/50; 290/54

(57) ABSTRACT

An apparatus and method is disclosed for generating power from the energy of fluid flow in a conduit, such as a pipeline or production tubing of a wellbore. A fan may be comprised of a plurality of blades positioned circumferentially around a central cavity. The blades may be adapted for receiving fluid flow and transmitting energy of fluid flow to rotate the fan. The fan may be configured for generating rotational movement of a magnet relative to an electromagnetic winding to produce electrical energy. The central cavity may be adapted for receiving objects such as wellbore intervention tools or other devices for insertion into the central cavity.

### FIELD OF THE INVENTION

The invention is directed to a system, apparatus and method for generating power in a conduit, such as in a production tubing of a wellbore or in a pipeline.

### BACKGROUND OF THE INVENTION

In modern oil and gas production, it is desirable to position in a wellbore devices that require a source of electrical power. Energy consuming devices may be employed downhole to perform a variety of tasks. For example, sensors may be positioned within a casing for monitoring fluid flow pressure, temperature, and flow rates. Optical or acoustic sensors may be used as well. Other sensing devices can be useful to measure fluid viscosity and density.

With the advent of reservoir management techniques, sophisticated monitoring and valve systems have been integrated into wellbore casing. This allows portions of a subterranean formation to be open to producing oil/gas upwards in the wellbore, while at the same time other portions of the formation are sealed to avoid production into the wellbore. This may be accomplished by controlling downhole valves. To achieve maximum reservoir performance, it may be necessary to flow from only selected portions of the reservoir at a given time. Subterranean flow monitors and flow control systems may require an external power source.

Downhole telemetry systems may be powered with a downhole power supply. These systems include a mechanism for generating a seismic signal that travels up the borehole. The resulting signal may be received and collected for additional analysis. Acoustic devices may include transmitters and receivers, such as piezoelectric, electromagnetic acoustic transducers, lasers, signal transmitters, signal receivers and flexural resonators. Also, shaped charges in a perforating gun may employ downhole electrical current as well. Such perforating apparatus may in some instances benefit from the use of an available power source.

Oil and gas pipelines carry hydrocarbons across vast expanses of remote territory. It is often desirable to have a source of electrical power along the pipeline route. However, pipeline routes may not be near conventional electrical power sources. Such electrical power could be used to illuminate the pipeline area for maintenance or security, transmit wireless signals corresponding to pipeline flow conditions or temperature, or provide for other electrically powered pipeline related activities.

There exists a need in the industry for a device that can supply downhole power in a relatively harsh wellbore environment without causing interference with other necessary exploration and production activities. A device that can generate or supply downhole power without interfering with wellbore intervention activities would be highly desirable. A device that can provide electrical power, using the flowing fluids in the pipeline as a power source, along a remote pipeline route, also would be very beneficial.

### SUMMARY OF THE INVENTION

An apparatus and method for generating power from fluid flow in a conduit is disclosed. The apparatus may comprise a fan, the fan being comprised of a plurality of blades positioned circumferentially around a central cavity. The blades may be adapted for receiving fluid flow and transmitting energy of fluid flow to rotate the fan. An electromagnetic winding and a magnet may be provided as well. The fan may be configured for generating rotational movement of the magnet relative to the electromagnetic winding to produce electrical energy. The central cavity may be free from obstruction and may be configured for receiving objects inserted into the central cavity.

In some embodiments of the invention, the magnet may be cylindrical in shape. The magnet may be connectively coupled to the fan with a gear or other energy transfer mechanism, the fan being adapted for movement of the energy transfer mechanism to cause rotational movement of the magnet relative to the electromagnetic winding. Other apparatus and methods for coupling the fan to the magnet or to the electromagnetic winding may be employed as well.

In at least one embodiment of the invention, the conduit may be a production tubing, and the apparatus may be adapted for installation into a wellbore. In a wellbore having a production tubing, the production tubing having a first diameter, the apparatus may comprise an annular expansion zone. The annular expansion zone may be positioned circumferentially outside the first diameter of the production tubing. The fan may be positioned in the expansion zone to receive fluid flow in the expansion zone. The central cavity may be adapted for receiving wellbore tools as well. The electromagnetic winding may be cylindrical in shape. The electromagnetic winding also may be positioned circumferentially outside of the magnet.

An electrical load may be connected to the electromagnetic winding. The electrical load may be selected from one or more of the following: sensor, sliding sleeve, telemetry mechanism, transducer, actuator, pump, processor, energy storage device, capacitor and controller. The electrical load may comprise an energy storage device, the energy storage device being adapted for storing electrical energy produced by the apparatus, wherein the energy storage device may be configured for supplying power during time periods when there is insufficient fluid flow within the apparatus to supply electrical power.

An apparatus as described also may be employed for application in a pipeline. In this application, the apparatus may comprise a fan, the fan being comprised of a plurality of blades positioned circumferentially, the blades being adapted for receiving fluid flow and transmitting energy of the fluid flow to rotate the fan. A cylindrical magnet may be positioned circumferentially in relation to the fan, the fan being coupled to the magnet by a gear, an electromagnetic winding being positioned circumferentially with respect to the magnet, wherein the fan is configured for generating rotational movement of the magnet within the electromagnetic winding to produce electrical energy. The apparatus further comprises a central cavity within the plurality of blades, which allows for the passage of pipeline cleaning devices through the pipeline.

In the application of the method for generating power in a wellbore, fluid flows through the wellbore. The wellbore has a conduit, such as a production tubing, which has a first diameter. The fluid is expanded into an annular expansion zone, the annular expansion zone being located circumferentially outside of the first diameter of the production tubing. Then, the fluid may impact upon a fan within the annular expansion zone. The fan may be comprised of a plurality of blades positioned circumferentially within the annular expansion zone. The fan may be coupled to a magnet, or in other embodiments, the fan may be coupled to an electromagnetic winding. The fan is rotated, which transmits rotational energy to cause the magnet to move relative to the electromagnetic winding, thereby producing electrical energy.

Electrical energy may be stored in an energy storage device, such as a battery or capacitor. In other applications, the electrical energy may activate a sensor. The electrical energy may be employed to activate a sliding sleeve, a telemetry mechanism, a transducer, an actuator, a pump, an actuator, a processor, or the like. In some embodiments, the electrical energy may charge an energy storage device, battery or capacitor. The energy may be employed to activate a controller.

### BRIEF DESCRIPTION OF THE FIGURES

The invention may be illustrated by way of example as shown in the following Figures:

FIG. 1 shows a partial cross-sectional view of the production tubing comprising a first embodiment of the apparatus of the invention as positioned in a wellbore;

FIG. 2 is a longitudinal cross-sectional view of apparatus with details of the fan and blade configuration;

FIG. 3 is a side cross-sectional view taken along line 3-3 of FIG. 2, showing the configuration of the first embodiment of the apparatus;

FIG. 4 reveals a second embodiment of the invention, in longitudinal cross-section, showing a somewhat different configuration of the blade and fan assembly;

FIG. 5 is a cross-sectional view taken along lines 5-5 of FIG. 4, revealing the structure of the second embodiment of the invention; and

FIG. 6 shows a third embodiment of the invention as employed in a pipeline.

### DETAILED DESCRIPTION OF THE INVENTION

The invention is shown in several embodiments in the Figures, and persons of skill in the art will recognize that other embodiments having other configurations could be envisioned, which are within the scope and spirit of the disclosed invention.

One advantage of the invention is that in some cases, the structure of the device facilitates the use of wellbore intervention operations during the time that the device is installed in the wellbore. Such operations may include, for example, the insertion of coiled tubing or wireline or cleaning devices into the wellbore and/or into the production tubing. Such operations may be performed without conflict with the apparatus of the invention, in part due to the fact that blades of the apparatus reside outside of the conduit first diameter, as further discussed herein. Likewise, for embodiments of the invention that are employed in pipelines, the cleanout of pipelines by pigging devices is facilitated in a similar manner. Thus, power may be generated by flowing fluid without substantial obstruction of the working area.

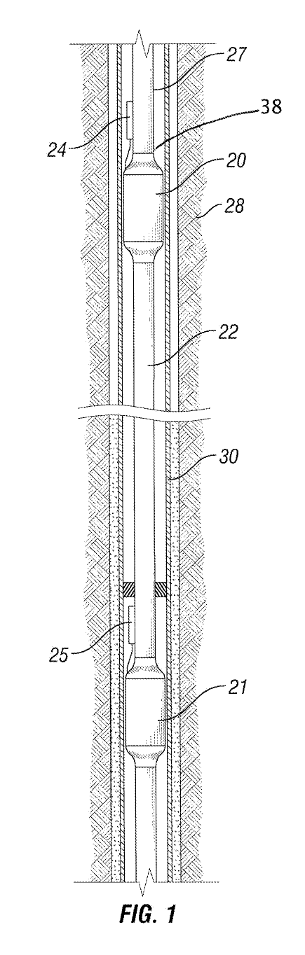

Turning to FIG. 1, apparatus 20, 21 is shown positioned along a conduit 22 comprising production tubing 38 in a wellbore 27. The wellbore 27 is installed within subterranean formation 28 by way of a cemented casing 30. Optional energy storage devices 24, 25 are shown in electrical communication with apparatus 20, 21 respectively. In this configuration, wellbore intervention tools (not shown) may be lowered downwards into the production tubing 38 as needed during normal wellbore operations.

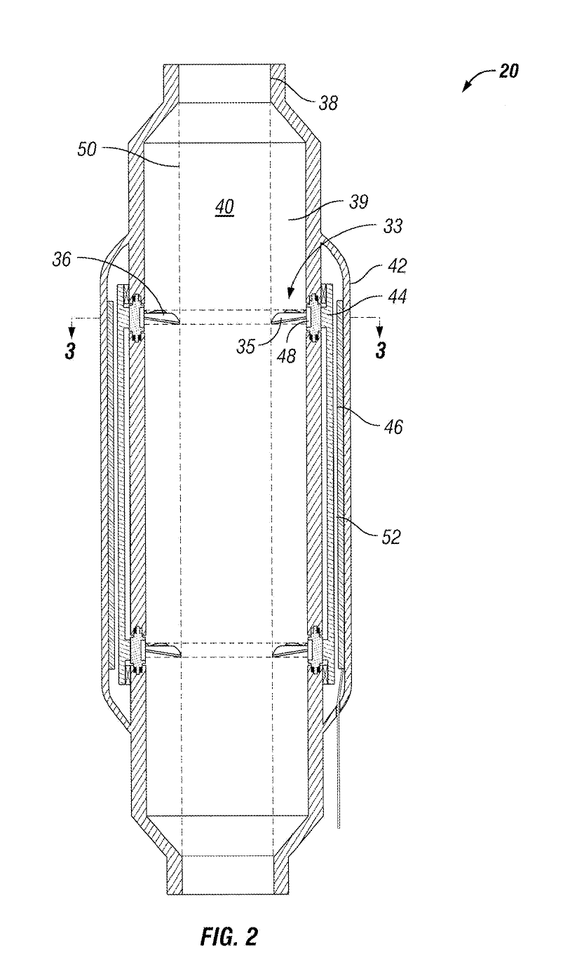

FIG. 2 shows apparatus 20 in cross-section, with a central cavity 40 along the center of production tubing 38. A fan 33 comprises a plurality of blades 35, 36 which are provided circumferentially around the central cavity 40. Fluid flow through production tubing 38 proceeds along and within the first diameter 50 until the fluid reaches the annular-shaped expansion zone 39, at which point the fluid may be expanded radially within the production tubing 38 so as to contact blades 35, 36 causing rotation of fan 33. Blade 35 is connected to bearing 48, which is provided in operable unison with magnet 44. Rotation of fan 33 causes rotation of circular magnet 44 within the circular electromagnetic winding 46 to produce electricity. Housing 42 is connected to production tubing 38, in one embodiment of the invention. A space 52 is provided in between the electromagnetic winding 46 and the magnet 44.

It should be recognized that other embodiments of the invention (not shown) which employ a rotating electromagnetic winding 46 with a stationary magnet 44 also could produce electrical current in a similar manner. So long as the magnet 44 moves relative to the electromagnetic winding 46, current may be produced. Further, it is not necessary that such structures be circular, and many other geometries could be applied by persons of skill in the art.

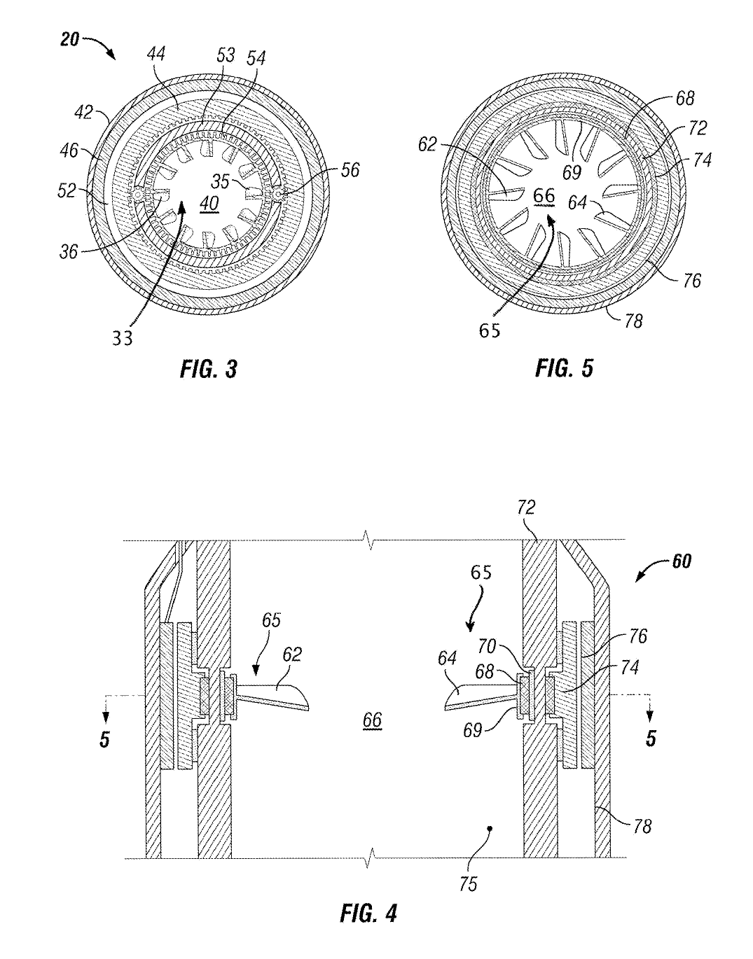

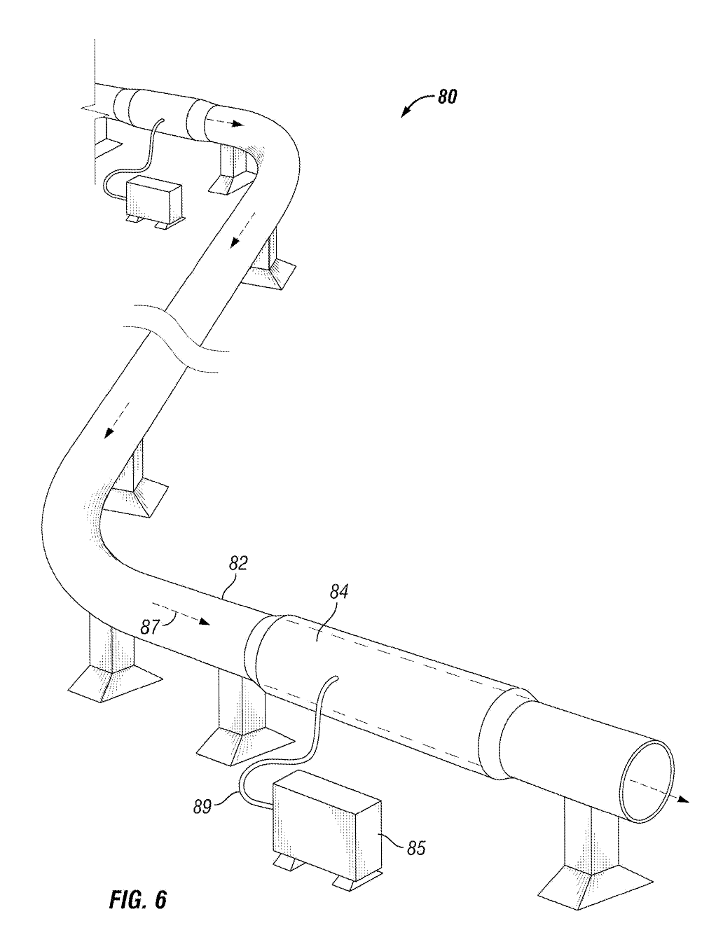

FIG. 3 shows a cross-sectional view along lines 3-3 of FIG. 2, in which further internal details of apparatus 20 are visible. Housing 42 surrounds electromagnetic winding 46, which is circular and in this instance, is fixed in place. Magnet 44 rotates within the electromagnetic winding 46 when the magnet 44 is driven by gear 56. Gear 56 receives mechanical force from teeth 54. Coupler 53 rests between teeth 54 and magnet 44. Teeth 54 are driven by the action of the plurality of blades 35, 36 constituting fan 33. The fan 33 is driven in a circular motion by fluid passing through central cavity 40, and the speed of the fan 33 is related to the velocity of fluid passing through central cavity 40.

In FIG. 4, a second embodiment of the invention is shown, with a close-up view of the blades provided circumferentially around central cavity 66. For example, blades 62, 64 are shown as part of fan 65 extending into the central cavity 66, and are positioned to receive fluid flow. Apparatus 60 further comprises support 69 in close association with blade 64. Blade 64 is attached to first magnet 68, which is provided adjacent bearing 70, and adjacent wall 72. A second magnet 74 is positioned on the outside of bearing, and is capable of magnetic communication with magnet 68. Thus, when first magnet 68 is caused to move by fluid forces in the expansion zone 75 inpinging upon the plurality of blades, such as blades 62, 64, then magnetic forces between first magnet 68 and second magnet 74 result in rotation of second magnet 74 about its central axis. This rotation of second magnet 74 inside the circular electromagnetic winding 76 causes the production of electrical current which may be transported within or outside of housing 78 and stored in an energy storage device 24, 25 as shown in FIG. 1 for later use.

In the configuration as shown in FIG. 4, wellbore intervention tools (not shown) may be lowered downwards into the production tubing and through central cavity 66 as needed during normal wellbore operations.

Yet another embodiment of the invention is shown in FIG. 6. A pipeline 80 carries a fluid such as hydrocarbons, gas, water, or other fluid along fluid flow arrow 87. The conduit 82 expands as it reaches apparatus 84, providing an expansion zone similar to that shown in the other embodiments of the invention as described herein. Electrical power may be generated in a similar manner by action of the fluid upon blades (not shown in FIG. 6) to turn a fan (not shown) causing electricity generation along conductive cable 89 to energy storage device 85. The power thus generated and stored may be used for many different activities along the pipeline route, including but not limited to: providing illumination/lighting along the pipeline, activating security devices, providing cathodic protection from pipeline corrosion, or other uses that would be associated with pipeline activities. Further, the transmission of pigs along the pipeline for cleaning and other purposes are not hindered by the apparatus 84, because the central cavity of the pipeline remains clear for transmission of devices through the conduit 82.

The components of system for power generation by movement of fluid and its various components, as illustrated by the invention, may be made from a wide variety of materials. The system may include DC generators, AC generators, asynchronous systems, synchronous systems, permanent magnets including rare earth magnets and the like. These materials may include metallic or non-metallic, magnetic or non-magnetic, elastomeric or non-elastomeric, malleable or non-malleable materials. Examples of suitable materials include metals, plastics, polymers, wood, alloys, composites and the like. If metals are employed, they may be selected from one or more metals, such as steel, stainless steel, aluminum, titanium, nickel, magnesium, or any other structural metal that is suitable for use in a high temperature and high pressure environment. Examples of plastics or polymers may include, but are not limited to, nylon, polyethylene (PE), polypropylene (PP), polyester (PE), polytetraflouroethylene (PTFE), acrylonitrile butadiene styrene (ABS), polyvinylchloride (PVC), polycarbonate, extruded organic thermosets such as polychloroprene and combinations thereof, among other plastics. The system may be molded, sintered, welded, machined or formed in a manner to make the required pieces for assembly.

The invention is shown by example in the illustrated embodiments. However, it is recognized that other embodiments of the invention having a different configuration but achieving the same or similar result are within the scope and spirit of the claimed invention.

1. An apparatus for generating power from fluid flow in a conduit, the apparatus comprising:
(a) a fan, the fan being comprised of a plurality of blades positioned circumferentially around a central cavity, the blades being adapted for receiving fluid flow and transmitting energy of fluid flow to rotate the fan,
(b) an electromagnetic winding, and
(c) a magnet,
(d) wherein the fan is configured for generating rotational movement of the magnet relative to the electromagnetic winding to produce electrical energy, and
(e) further wherein the central cavity is substantially free from obstruction and is adapted for receiving objects inserted into the central cavity.

2. The apparatus of claim 1 wherein the magnet is cylindrical in shape.

3. The apparatus of claim 2 wherein the magnet is connectively coupled to the fan with a gear, the fan being adapted for movement of the gear to cause rotational movement of the magnet relative to the electromagnetic winding.

4. The apparatus of claim 1 wherein the conduit comprises production tubing and the apparatus is adapted for installation into a wellbore, the wellbore having inserted therein production tubing, the production tubing having a first diameter, the production tubing having an annular expansion zone, the annular expansion zone being positioned circumferentially outside the first diameter of the production tubing, wherein the fan is positioned within the expansion zone to receive fluid flow in the expansion zone, further wherein the central cavity is adapted for receiving wellbore tools.

5. The apparatus of claim 2 wherein the electromagnetic winding is cylindrical in shape.

6. The apparatus of claim 5 wherein the electromagnetic winding is positioned circumferentially outside of the magnet.

7. An apparatus for generating power within a wellbore or pipeline, the apparatus comprising:
a fan, the fan being comprised of a plurality of blades positioned circumferentially, the blades being adapted for receiving fluid flow and transmitting energy of the fluid flow to rotate the fan, a cylindrical magnet positioned circumferentially outside of the fan, the fan being coupled to the magnet by a gear, an electromagnetic winding positioned circumferentially outside of the magnet, wherein the fan is configured for generating rotational movement of the magnet within the electromagnetic winding to produce electrical energy, the apparatus further comprising a central cavity within the plurality of blades, the central cavity being adapted for receiving intervention tools.

8. The apparatus of claim 7 wherein an electrical load is connected to the electromagnetic winding.

9. The apparatus of claim 8 wherein the electrical load is selected from one or more of the following: sensor, sliding sleeve, telemetry mechanism, transducer, actuator, pump, processor, energy storage device, capacitor and controller.

10. The apparatus of claim 9 wherein the electrical load is an energy storage device, the energy storage device being adapted for storing electrical energy produced by the apparatus, wherein the energy storage device may be configured for supplying power during time periods when there is insufficient fluid flow within the apparatus to supply needed electrical power.

11. An apparatus for generating power in association with a pipeline, the apparatus comprising:
a fan, the fan being comprised of a plurality of blades positioned circumferentially, the blades being adapted for receiving fluid flow and transmitting energy of the fluid flow to rotate the fan, a cylindrical magnet positioned circumferentially in relation to the fan, the fan being coupled to the magnet by a gear, an electromagnetic winding positioned circumferentially with respect to the magnet, wherein the fan is configured for generating rotational movement of the magnet within the electromagnetic winding to produce electrical energy, the apparatus further comprising a central cavity positioned within the plurality of blades.

12. A method for generating power within a wellbore, the method comprising:
(a) flowing a fluid through the wellbore, the wellbore having a production tubing, the production tubing having a first diameter,
(b) expanding the fluid into an annular expansion zone, the annular expansion zone being located circumferentially outside of the first diameter of the production tubing,
(c) impacting the fluid upon a fan within the annular expansion zone, the fan being comprised of a plurality of blades positioned circumferentially within the annular expansion zone, the fan being coupled to a magnet,
(d) rotating the fan,
(e) transmitting rotational energy from the fan to a magnet within an electromagnetic winding,
(f) moving the magnet relative to the electromagnetic winding, and
(g) producing electrical energy.

13. The method of claim 12 comprising the additional step of:
(h) storing the electrical energy in a energy storage device.

14. The method of claim 12 comprising the additional step of:
(h) employing the electrical energy to activate a sensor.

15. The method of claim 12 comprising the additional step of:
(h) employing the electrical energy to activate a sliding sleeve.

16. The method of claim 12 comprising the additional step of:
(h) employing the electrical energy to activate a telemetry mechanism.

17. The method of claim 12 comprising the additional step of:
(h) employing the electrical energy to activate a transducer.

18. The method of claim 12 comprising the additional step of:
(h) employing the electrical energy to activate an actuator.

19. The method of claim 12 comprising the additional step of:
(h) employing the electrical energy to activate a pump.

20. The method of claim 12 comprising the additional step of:
(h) employing the electrical energy to activate a processor.

21. The method of claim 12 comprising the additional step of:
(h) employing the electrical energy to charge an energy storage device.

22. The method of claim 12 comprising the additional step of:
(h) employing the electrical energy to charge a battery.

23. The method of claim 12 comprising the additional step of:
(h) employing the electrical energy to charge a capacitor.

24. The method of claim 12 comprising the additional step of:
(h) employing the electrical energy to activate a controller.
